(19) United States
(12) Patent Application Publication
(10) Pub. No.: US 2026/0239195 A1
(43) Pub. Date: Aug. 13, 2026

(54) DISCONTINUOUS COVERAGE FOR DEVICES IN A NON-TERRESTRIAL NETWORK

(71) Applicant: Apple Inc., Cupertino, CA (US)

(72) Inventors: Yuqin CHEN, Beijing (CN); Fangli XU, Beijing (CN); Haijing HU, Los Gatos, CA (US); Peng CHENG, Beijing (CN)

(21) Appl. No.: 19/156,659

(22) PCT Filed: Feb. 16, 2023
(86) PCT No.: PCT/CN2023/076464

§ 371 Date: Aug. 14, 2025

(51) Int. Cl. H04W 52/02

(52) U.S. Cl. CPC H04W 52/0212

(57) ABSTRACT

Disclosed are methods, systems, and computer-readable medium to perform operations including receiving, by a user equipment and from a non-terrestrial base station, a power saving mode (PSM) configuration comprising a primary paging time window (PTW) and an extended PTW. The UE is periodically served by the non-terrestrial base station that provides network coverage to the UE during a periodic coverage time window. The operations further include applying the PSM configuration to communicate with the non-terrestrial base station during at least one of the primary PTW or the extended PTW that overlaps with the periodic coverage time window.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, to increase network coverage and support use cases that are beyond the capabilities of ground-based (e.g., terrestrial) infrastructure, 3GPP has released standards that introduce a non-terrestrial network (NTN) that uses airborne or space-borne platforms (e.g., non-geo-stationary satellites) to serve as access nodes or base stations. A non-terrestrial network can be integrated with terrestrial infrastructure, e.g., 5G NR infrastructure, to supplement the network coverage of the terrestrial infrastructure. A non-terrestrial network can also be used to independently provide network coverage to devices, e.g., Internet of Things (IoT) devices, that are located in areas without terrestrial network coverage.

### SUMMARY

In accordance with one aspect of the present disclosure, a method to be performed by a user equipment (UE) that is periodically served by a non-terrestrial base station that provides network coverage to the UE during a periodic coverage time window. The method involves receiving, from the non-terrestrial base station, a power saving mode (PSM) configuration including a primary paging time window (PTW) and an extended PTW; and applying the PSM configuration to communicate with the non-terrestrial base station during at least one of the primary PTW or the extended PTW that overlaps with the periodic coverage time window.

Other versions include corresponding systems, apparatus, and computer programs to perform the actions of methods defined by instructions encoded on computer readable storage devices. These and other versions may optionally include one or more of the following features.

In some implementations, the extended PTW includes a preceding window that precedes the PTW and a succeeding window that succeeds the PTW.

In some implementations, the preceding window starts at a first predetermined time before the PTW, and where the succeeding window ends at a second predetermined time after the PTW.

In some implementations, applying the PSM configuration to communicate with the non-terrestrial base station during at least one of the primary PTW or the extended PTW involves: starting the preceding window at the first predetermined time; and sending the succeeding window at the second predetermined time.

In some implementations, the first predetermined time and the second predetermined time are received from the non-terrestrial base station or derived by the UE.

In some implementations, the first predetermined time and the second predetermined time are based on a number of passes that the non-terrestrial base station has made in a coverage area of the UE.

In some implementations, the method further involves performing, during the primary PTW, a radio resource management (RRM) action according to a first frequency.

In some implementations, the method further involves performing, during the extended PTW, the RRM action according to a second frequency, where the second frequency is an integer multiple of the first frequency.

In some implementations, the method further involves determining not to communicate with the non-terrestrial base station outside of the PTW or the extended PTW.

In some implementations, the method further involves prior to receiving the PSM configuration, sending assisted information to the non-terrestrial base station.

In some implementations, the assisted information includes an update request sent in a non-access stratum (NAS) message.

In some implementations, the update request includes at least one of a UE location or a UE movement status.

In some implementations, the update request includes a report prediction error indicating statistics related to the timing mismatch.

In some implementations, the assisted information is sent via communications for Self-Organizing Networks (SON).

In some implementations, the method further involves detecting a mismatch between the periodic coverage time window and the primary PTW, where the assisted information is sent to the non-terrestrial base station in response to detecting the mismatch.

In accordance with another aspect of the present disclosure, a method to be performed by UE that is periodically served by a plurality of non-terrestrial base stations that provide network coverage to the UE during respective periodic coverage time windows. The method involves receiving a plurality of power saving mode (PSM) configurations corresponding to the plurality of non-terrestrial base stations, the plurality of PSM configurations including a plurality of paging time window (PTWs); and performing a plurality of radio resource management (RRM) actions based on the plurality of PSM configurations.

Other versions include corresponding systems, apparatus, and computer programs to perform the actions of methods defined by instructions encoded on computer readable storage devices. These and other versions may optionally include one or more of the following features.

some implementations, performing the plurality of RRM actions involves performing a portion of the plurality of RRM actions outside of the plurality of PTWs, where the portion of RRM actions is performed according to a frequency based on a number of layers and lengths of idle cycles of the plurality of PSM configurations.

In accordance with another aspect of the present disclosure, a method to be performed by a UE that is periodically served by a non-terrestrial base station that provides network coverage to the UE during a periodic coverage time window. The method involves: receiving a plurality of power saving mode (PSM) configurations corresponding to the plurality of non-terrestrial base stations, the plurality of PSM configurations including a plurality of paging time window (PTWs); detecting a timing mismatch between the periodic coverage time window and the PTW; and in response, performing one or more mitigating actions to mitigate the timing mismatch.

Other versions include corresponding systems, apparatus, and computer programs to perform the actions of methods defined by instructions encoded on computer readable storage devices. These and other versions may optionally include one or more of the following features.

In some implementations, detecting the timing mismatch involves determining that the timing mismatch between the periodic coverage time window and the PTW is greater than a predetermined threshold.

In some implementations, performing the one or more mitigating actions to mitigate the timing mismatch involves: determining a time adjustment value; and extending the PTW by at least one of: (i) changing a start time of the PTW to a revised start time by subtracting the time adjustment value from an original start time, or (ii) changing an end time of the PTW to a revised end time by adding the time adjustment value to an original end time.

In some implementations, the method further involves determining not to perform radio resource management (RRM) actions before the revised start time or after the revised end time.

In some implementations, the time adjustment value is based on a number of passes that the non-terrestrial base station has made in a coverage area of the UE.

In some implementations, the time adjustment value is received from the non-terrestrial base station or derived by the UE.

In some implementations, performing the one or more RRM actions to mitigate the mismatch involves skipping the one or more RRM actions in the PTW.

In some implementations, performing one or more mitigating actions to mitigate the timing mismatch involves sending assisted information to the non-terrestrial base station.

In some implementations, the assisted information includes an update request sent in a non-access stratum (NAS) message.

In some implementations, the update request includes at least one of a UE location or a UE movement status.

In some implementations, the update request requests an updated PSM configuration, and the update request includes an offset value indicative of the timing mismatch.

In some implementations, the update request includes a report prediction error indicating statistics related to the timing mismatch.

In some implementations, the assisted information is sent via communications for Self-Organizing Networks (SON).

In some implementations, the timing mismatch is a first timing mismatch, and the method 620 further involves receiving an updated PSM configuration including an updated PTW, where a second timing mismatch between the periodic coverage time window and the updated PTW is less than the first timing mismatch.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1 illustrates an example extended discontinuous reception (eDRX) operation.

FIGS. 2A-2B illustrate an example non-terrestrial network, according to some implementations.

FIG. 3 illustrates an example enhanced eDRX configuration, according to some implementations.

FIG. 4 illustrates an example eDRX information element (IE), according to some implementations.

FIG. 5 illustrates an example multi-satellite coverage over time, according to some implementations.

FIG. 6A illustrates a flowchart of an example method, according to some implementations.

FIG. 6B illustrates a flowchart of another example method, according to some implementations.

FIG. 6C illustrates a flowchart of another example method, according to some implementations.

FIG. 7 illustrates a user equipment (UE), according to some implementations.

FIG. 8 illustrates an access node, according to some implementations.

FIG. 9 is a block diagram of an example computing device, according to some implementations.

### DETAILED DESCRIPTION

In line with the discussion above, a non-terrestrial network (NTN) may include one or more non-geo-stationary satellites that serve user equipment devices (UEs), such as Internet-of-Things (IoT) devices that are located outside of the coverage area of a terrestrial network. In this arrangement, however, the network coverage of the non-terrestrial network in a particular area may be discontinuous due to the number of satellites that are serving the area, the orbits of the satellites, and/or other factors. Thus, a UE located in that particular area may experience periodic network coverage, e.g., periods of network coverage called “available coverage time windows” and periods with no network coverage called “unreachability time windows” or “coverage gaps.” The discontinuous coverage presents challenges to the operation of the UE and/or the network. As an example, discontinuous coverage may result in excessive UE power consumption due to a UE repeatedly attempting to connect to the network during coverage gaps.

Release 17 of the Third Generation Partnership Project (3GPP) standards include configurations for supporting discontinuous coverage without excessive UE power consumption and/or without excessive failures or recovery actions. At a high level, these configurations take into account a UE's unreachability time windows when configuring the UE's operation. For example, a non-terrestrial network may configure the UE to operate in a power saving mode (PSM) in which the UE alternates between a sleep mode (or idle mode) and an active mode (or connected mode). The network configures the PSM such that active time windows of the PSM overlap with the network's available coverage time windows, and such that the idle time windows of the PSM overlap with the network's coverage gaps. Thus, the UE can perform radio resource management (RRM) actions (e.g., mobility management, connection management, etc.) and/or receive data during the available coverage time windows. Conversely, the UE does not excessively attempt to perform RRM actions and/or receive data during the coverage gaps, thereby preserving resources.

More specifically, a core network entity, perhaps an Access and Mobility Management Function (AMF) or a Mobility Management Entity (MME), determines mobility management and PSM parameters for the UE based on the UE's unreachability time windows. The AMF/MME obtains information indicative of the unreachability time windows from an application function (AF), the UE itself, or an Operations, Administration, and Maintenance (OAM) entity. The AMF/MME also takes into account information such as location information, mobility information, and/or trajectory information of the UE. The AMF/MME then configures the UE with the selected parameters before a coverage gap occurs.

One of the PSMs that the network may configure the UE with is extended discontinuous reception (eDRX). In eDRX, the UE is configured with a series of eDRX cycles for a period of time. Each eDRX cycle includes a duration, called a paging time window (PTW), in which the UE can send/receive data to/from the network. Each eDRX cycle also includes idle durations outside of the PTW. Further, each PTW may include a series of DRX cycles. Each DRX cycle provides an occasion, called an “on duration,” in which the UE can send/receive data to/from the network. Each DRX cycle also provides a period, called an “off duration,” in which the UE decreases the frequency of or eliminates data traffic.

In existing systems, if the network configures the UE to operate in eDRX, the network may configure different UE behaviors inside and outside of the PTW. The network may configure the UE to operate as follows outside of the PTW:
For high priority frequency: The UE shall search every layer of higher priority at least every T_{higher_priority_search}=(60*N_{layers}) seconds when the UE is not configured with eDRX IDLE cycle, and at least every T_{higher_priority_search}=MAX(60 * N_{layers}, one eDRX IDLE cycle) when UE is configured with eDRX_IDLE cycle, where N_{layers} is the total number of configured higher priority E-UTRA, UTRA FDD, UTRA TDD, CDMA2000 1x, HRPD and NR carrier frequencies and is additionally increased by one if one or more groups of GSM frequencies is configured as a higher priority.

And the network may configure the UE to operate as follows inside of the PTW:
If DRX is configured, the UE performs a measurement every DRX cycle.
Else, the UE performs a measurement every eDRX cycle.

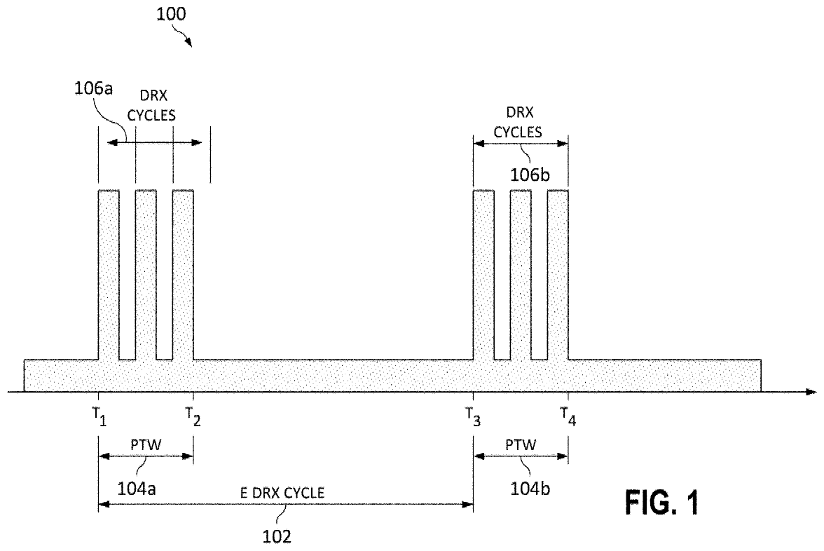

FIG. 1 illustrates an example eDRX operation 100. As shown in FIG. 1, the eDRX operation 100 includes a plurality of eDRX cycles, such as eDRX cycle 102. Each eDRX cycle includes a PTW, such as PTWs 104a, 104b. Each PTW may include a number of DRX cycles, such as DRX cycles 106a, 106b.

In some scenarios, however, a mismatch between the network's available coverage window and the UE's active time window may develop over time. The mismatch may result from the UE's movement over time and/or from errors in the UE's calculation of the next available coverage window. The mismatch may compound over time, and can reach or exceed 230 seconds. Due to this mismatch, the UE may partially or completely miss the available coverage window, and therefore, the UE's network connectivity may partially or completely deteriorate.

This disclosure provides systems and methods for resolving issues that may arise in the deployment of non-terrestrial networks. As described in more detail below, this disclosure provides systems and methods for avoiding or mitigating the timing mismatch between the network's available coverage windows and the UE's active time windows. Additionally, this disclosure provides systems and methods for avoiding or mitigating errors that may arise from different non-terrestrial base stations having different available coverage times and from the uneven distribution of the periods between when satellites become available to the UE. Further, this disclosure describes both access stratum (AS) centric and non-access stratum (NAS) centric solutions.

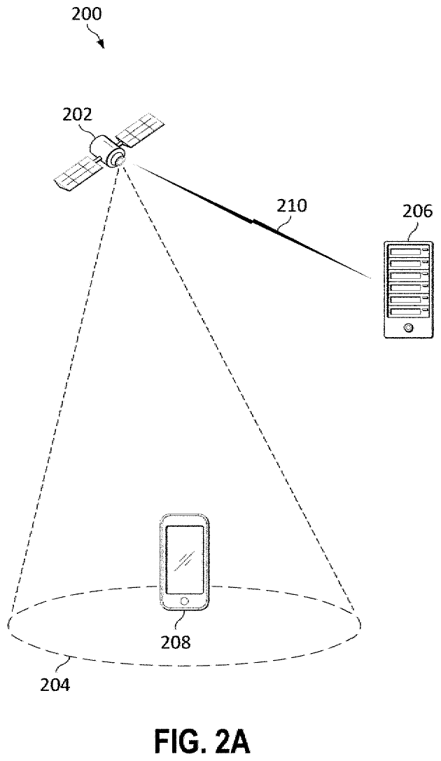

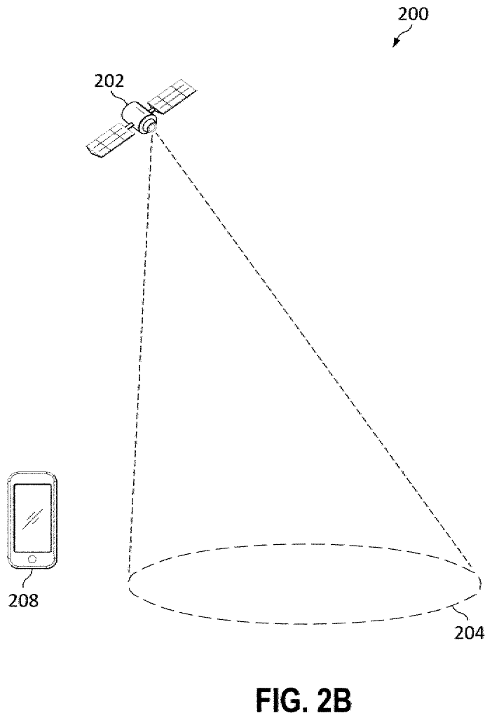

FIG. 2A illustrates an example non-terrestrial network 200, according to some implementations. Generally, the non-terrestrial network 200 can include any network that uses non-terrestrial components, such as satellites, airplanes, unmanned aerial vehicles (UAVs), etc., to provide network coverage to a UE. In this example, the non-terrestrial network 200 includes a non-geo-stationary satellite 202 (“satellite 202”) that has a moving coverage area 204. The non-terrestrial network 200 also includes a core network 206, e.g., a 4G or 5G core network. Among other entities, the core network 206 can include an AMF or an MME. Although FIG. 2A shows the satellite 202 directly coupled to the core network 206 via link 210, the satellite 202 may alternatively be indirectly coupled to the core network 206, perhaps via a terrestrial base station (not illustrated). In such examples, the link between the satellite 202 and the terrestrial base station is called a feeder link.

The non-terrestrial network 200 can serve UEs that are located in a coverage area of one of the non-terrestrial components of the network. For example, the non-terrestrial network 200 can serve a UE 208 when the UE is located within the coverage area 204. The UE 208 and any other UE in the system may be, for example, laptop computers, smartphones, tablet computers, machine-type devices such as smart meters or specialized devices for healthcare, intelligent transportation systems, IoT devices, or any other wireless devices with or without a user interface. The non-terrestrial network 200 can provide the UE 208 with network connectivity to a broader network (not shown in FIG. 1), such as the Internet.

In some implementations, the satellite 202 provides network services to UEs via a service link. The satellite 202 can implement either a transparent payload or a regenerative payload. A transparent payload refers to an arrangement in which the satellite 202 receives a signal and transmits an amplified version of the signal. For example, the satellite 202 receives uplink communications from the UE 208 on service link frequencies and transmits an amplified version of the signal to the core network 206 on feeder link frequencies, or may receive downlink communications from the core network 206 on the feeder link frequencies and transmit an amplified version of the signal to the UE 208 on the service link frequencies.

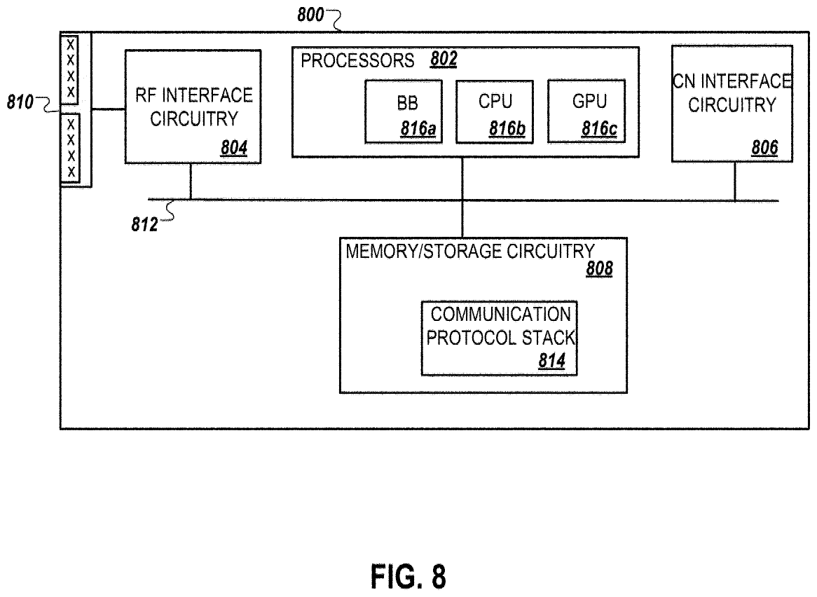

A regenerative payload refers to an arrangement in which the satellite 202 acts as a distributed unit (DU) or a base station (e.g., access node 800 in FIG. 8). In this arrangement, the satellite 202 regenerates received signals with signal-processing techniques (e.g., demodulation, decoding, switching, encoding, modulation, etc.) before being retransmitted. The satellite 202 generates one or more beams over a service area bounded by its field of view, which can depend on the antenna diagram and minimum elevation angle of the satellite. The coverage areas of the beams are typically elliptically-shaped, e.g., the coverage area 204.

The example shown in FIG. 2A is not intended to limit the exemplary embodiments in any way. The non-terrestrial network 200 may be integrated with a 5G NR radio access network (RAN) and/or other networks in any of a variety of manners. For example, the non-terrestrial network 200 may include a low earth orbit (LEO) constellation including an array of satellites and gateways with broad interconnectivity via ground-to-ground station (G2G) links, satellite-to-satellite (S2S) links, ground-to-satellite (G2S) links, and satellite-to-ground (S2G) links. Other types of satellite-based NTNs include geostationary-orbiting (GEO) satellites or medium-earth-orbiting (MEO) satellites. Additionally, the non-terrestrial network 200 may include more than one satellite that provides coverage to the UE 208 at overlapping or different times.

FIG. 2B illustrates the example non-terrestrial network 200 at a later time than shown in FIG. 2A, according to some implementations. As shown in FIG. 2B, the UE 208 is no longer in the coverage area 204, perhaps due to movement of the UE 208, movement of the satellite 202, or both. Because the UE 208 is no longer in the coverage area 204, the UE 208 is in a coverage gap and no longer receives network connectivity.

In line with the discussion above, the non-terrestrial network 200 may configure the UE 208 to operate in a PSM (e.g., eDRX, Mobile Initiated Connection Only [MICO], etc.). In some scenarios, there may be a timing mismatch between an available coverage time window of the non-terrestrial network 200 and an active time window of the UE 208. The mismatch may result from movement of the UE 208 and/or from an error in the UE's calculation of the next available coverage time window. Due to this mismatch, the UE 208 may partially or completely miss the available coverage time window. As result, the network connectivity of the UE 208 may partially or completely deteriorate.

In some implementations, the UE 208 is configured with one or more techniques for avoiding or mitigating the timing mismatch between the available coverage time window of the non-terrestrial network 200 and the active time window of the UE 208. As described in more detail below, the UE 208 and/or the non-terrestrial network 200 can apply one or more of the techniques (e.g., one technique on its own or a combination of two or more of the techniques) to avoid or mitigate the timing mismatch. The examples below assume that the PSM is eDRX. However, the UE 208 may additionally or alternatively be configured with other PSMs.

In some implementations, in a first technique, the non-terrestrial network 200 configures the UE 208 with an enhanced PSM configuration that avoids or mitigates a timing mismatch. The enhanced PSM configuration extends an original PTW (e.g., shown in FIG. 1) to facilitate for the UE 208 to receive paging outside of the original PTW, thereby avoiding or mitigating a paging loss. In an example, the non-terrestrial network 200 configures the UE 208 to extend the original PTW by hysteresis time adjustment values. Adjusting the PTW based on the time adjustment values causes the UE 208 to start the PTW at a time before, T_{Before}, the original PTW start time, and causes the UE 208 to end the PTW at a time after, T_{After}, the original PTW end time. Thus, the UE 208 wakes up before the original PTW start time and sleeps after the original PTW end time. For instance, if the original PTW is scheduled to occur between time T1 and T2, the new PSM configuration causes the UE 208 to wake up at time T0=T1−T_{Before}, and sleep at T3=T2+T_{After}. The adjustment time values T_{Before} and T_{After} can be the same or different.

Furthermore, the enhanced PSM configuration can instruct the UE 208 to perform different operations during the different time periods. For example, before T0 and after T3, the UE 208 is configured to not perform paging, measurements (e.g., cell search), eDRX measurements, or other RRM operations that may consume battery power. Between T0-T1 and T2-T3 (e.g., the extended PTW), the UE 208 is configured to periodically perform RRM operations based on a relaxed cycle length of N*DRX-length. Similarly, during the extended PTW, the non-terrestrial network 200 periodically pages the UE based on a cycle length of N*DRX-length. Here, N is an integer (configured by the network or hard coded into spec) and DRX-length is the DRX cycle length assigned to the UE 208. Further, between T1 and T2 (e.g., the original PTW), the UE 208 and the non-terrestrial network 200 are configured to perform legacy operations (e.g., periodic eDRX measurements).

In some implementations, the non-terrestrial network 200 configures the UE 208 with the enhanced PSM configuration prior to the mismatch being detected. In these implementations, the UE 208 can proactively avoid the mismatch. In other implementations, the non-terrestrial network 200 configures the UE 208 with the enhanced PSM configuration in response to detecting the mismatch, perhaps using one of the detection techniques described below. In these implementations, the UE 208 mitigates the detected mismatch.

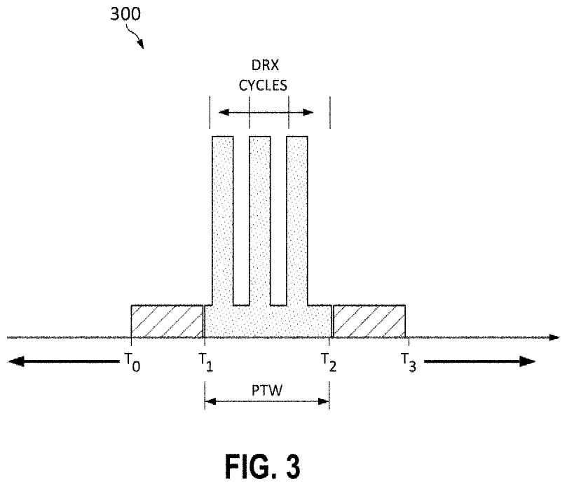

FIG. 3 illustrates an example enhanced eDRX configuration 300, according to some implementations. The eDRX configuration 300 is an enhanced PSM configuration that is implemented by a UE based on instructions received from the base station and/or in response to detecting a timing mismatch between an original PTW and the available coverage time window. In this example, the original PTW is scheduled between times T1 and T2. The revised PTW extends the original PTW to start at a time T0 and end at a time T3. T0 is equal to T1−T_{Before} and T3 is equal to T2+T_{After}.

In some implementations, the UE 208 is configured to use different time adjustment values for different satellite passes, where a satellite pass refers to each instance that the satellite 202 passes over the UE 208. The different time adjustment values may be specified in a table that is provisioned by the non-terrestrial network 200 or derived by both the UE 208 and the network. In some examples, the time adjustment values increase as the number of satellite passes increases. Doing so accounts for the error compounding that occurs over time.

In some implementations, in a second technique, the UE 208 is configured to determine that it is in a coverage gap during an active time window. In one example, the UE 208 makes the determination based on satellite trajectory information (e.g., satellite ephemeris data), which can be received through NAS, a user plan, or a System Information Block (SIB) received from the non-terrestrial network 200. In response to the determination, the UE 208 is configured to skip performing RRM operations, cell search, or any transmissions during the coverage gap.

In some implementations, in a third technique, the UE 208 is configured to report UE assisted information to the non-terrestrial network 200 in scenarios where there is an improper configuration of eDRX, e.g., due to UE movement. The improper configuration of eDRX, or eDRX error, may occur when the (original) configured eDRX cycle and the PTW do not match the (estimated) location of the UE 208. That is, the PTW does not match the available coverage time window in the current location of the UE 208. In these implementations, in response to detecting an improper configuration of eDRX, the UE 208 is configured to provide an update request to the non-terrestrial network 200 via a NAS message.

In some examples, the UE 208 provides its location and movement information to the non-terrestrial network 200. Doing so enables the non-terrestrial network 200 to use the location and movement information to provide the UE 208 with an updated eDRX configuration. In other examples, the UE 208 can use NAS signaling to send an eDRX update request to the non-terrestrial network 200. In these examples, the eDRX update request can be a DRX information element (IE) that includes an offset value that indicates the PTW location in the eDRX cycle. In yet another example, the UE 208 provides the non-terrestrial network 200 with an error report that includes a mean, variance, and/or histogram of the eDRX errors. The error report can additionally include a full log of each error.

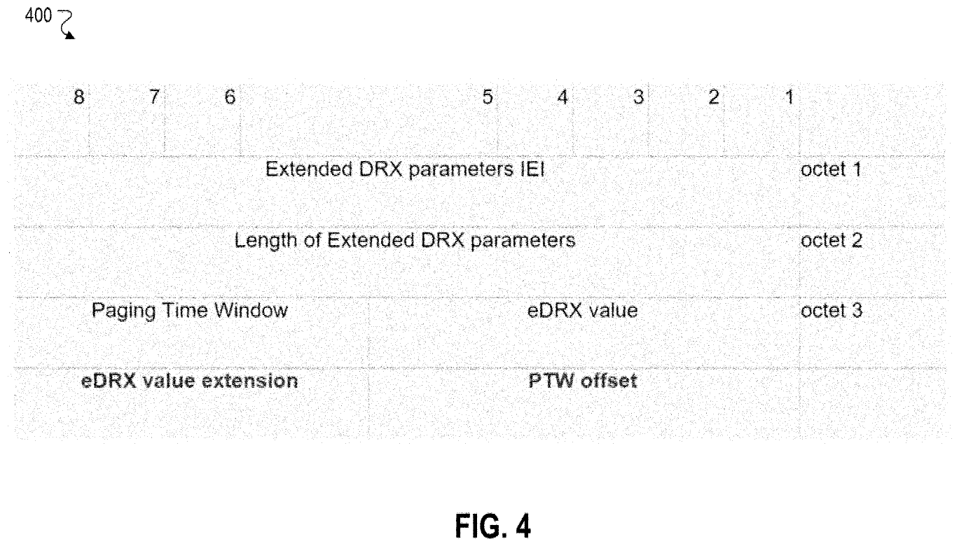

FIG. 4 illustrates an example eDRX information element (IE) 400, according to some implementations. As shown in FIG. 3, the eDRX IE 400 includes a PTW offset field 302. In some examples, a UE sends the eDRX IE 400 to the network as a request for updated eDRX information.

In some implementations, the UE 208 is configured to provide the UE assisted information to the non-terrestrial network 200 via self-organizing networks (SON)/minimization of drive tests (MDT) communications. In these implementations, the UE 208 is configured to trigger an event logging mechanism for events related to the timing mismatch. In one example, the UE 208 is configured to log events in which the UE cannot receive satellite signals during the (original) configured PTW. In another example, the UE 208 may additionally or alternatively be configured to log events in which the UE receives satellite signals only during a portion of the configured PTW. In this example, the UE 208 may be configured to log the event if the portion of the configured PTW is smaller than a predetermined threshold. For instance, the UE 208 may log events in which the UE receives signals during a portion of the configured PTW that is less than 50% of the entire configured PTW.

In some implementations, the non-terrestrial network 200 configures the UE 208 with the reporting configuration that instructs the UE how to perform the reporting. Based on the received configuration, the UE 208 logs events (e.g., coverage gaps, network unavailability information, etc.) over a period of time and reports the events once the UE connects back to the non-terrestrial network 200. In an example, the content of the report includes an NTN configuration (e.g., satellite ephemeris data), a Cell ID (e.g., physical cell ID [PCI] and absolute radio-frequency channel number (ARFCN), or cell global identity [CGI]), an NTN indication, and/or coverage gap durations. The non-terrestrial network 200 can use the reported information to adjust the eDRX configuration (e.g., eDRX pattern). The non-terrestrial network 200 then sends the UE 208 a revised configuration (e.g., using the first technique).

As previously described, the UE 208 may receive coverage from different satellites. In these scenarios, both the length of the coverage time of different satellites and the time periods between the different satellites is not the same. As a result, the available coverage windows of the different satellites are not evenly distributed. Thus, the UE 208 cannot use the same PSM configuration for the different satellites.

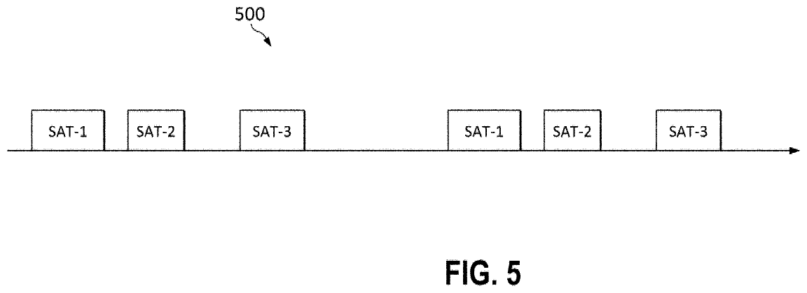

FIG. 5 illustrates an example multi-satellite coverage 500 over time, according to some implementations. In this example, three satellites, labelled as Sat-1, Sat-2, Sat-3, provide network coverage to an area. As shown by the different lengths of coverage time of each satellite, the length of coverage time is not identical across the satellites. Additionally, the pattern of the available time for satellites is not evenly distributed. That is, the time between the different satellites is not the same. Thus, a UE cannot use the same PSM configuration for the different satellites.

In some implementations, the non-terrestrial network 200 configures the UE 208 with a list of eDRX/PSM configurations, where each eDRX/PSM corresponds to a respective one of the satellites. The non-terrestrial network 200 may also configure the UE 208 to perform different operations inside and outside of the PTW associated with each satellite. In some examples, the UE 208 is configured to perform one of two operations outside of the PTWs. In the first operation, the UE 208 performs an RRM measurement every T_{higher_priority_search}=MAX(60*N_{layers}, the shortest eDRX_IDLE cycle). In the second operation, the UE 208 performs an RRM measurement every T_{higher_priority_search}=MAX(60*N_{layers}, the longest eDRX_IDLE cycle). N_{layers} is the total number of configured higher priority E-UTRA, UTRA FDD, UTRA TDD, CDMA2000 1x, HRPD and NR carrier frequencies and is additionally increased by one if one or more groups of GSM frequencies is configured as a higher priority. The eDRX_IDLE cycle is the length of time between the PTW in a configured eDRX operation.

In some examples, the operation that the UE 208 performs inside of a PTW is based on whether DRX is configured within that PTW. If DRX is not configured, then the UE 208 performs an RRM measurement every corresponding eDRX. Conversely, if DRX is configured, the UE 208 performs an RRM measurement every DRX.

The previously described solutions are NAS centric solutions. That is, the solutions are implemented in the interface (and protocols) between the UE 208 and the core network. The non-terrestrial network 200 may additionally or alternatively implement AS centric solutions. The AS centric solutions are implemented in the interface (and protocols) between the UE 208 and the satellite 202. From the perspective of the AS, the UE 208 may be in an RRC inactive state or in an RRC connected state when it experiences the discontinuous coverage. The non-terrestrial network 200 may implement the AS centric solutions in scenarios where the number of satellites is large, which results in a shorter discontinuous coverage duration.

In some implementations, the UE 208 is configured to apply an AS centric solution when the UE 208 is in a connected state and encounters a coverage gap due to discontinuous satellite coverage. In an example, in response to encountering a coverage gap due to discontinuous satellite coverage, the UE 208 is configured to transition to an “out of coverage” state. The UE 208 may be configured to do so using one or more approaches. In a first approach, the UE 208 declares radio link failure (RLF) with a specified reason called “coverage gap.” In response, the AS layer stops performing RRM and/or cell search and releases the AS configuration during the coverage gap. The AS layer informs the NAS layer of the “out of coverage due to DC satellite” state. The UE 208 then performs cell re-establishment to the next available satellite once coverage resumes.

In a second approach, the UE 208 autonomously releases the RRC connection and transitions to an RRC idle state. The UE 208 performs RRC set up to the next available satellite once coverage resumes. The AS layer informs the NAS layer about “out of coverage due to DC satellite.”

In a third approach, if the non-terrestrial network 200 configures handover/conditional handover (HO/CHO) to the UE 208, the UE 208 maintains the HO/CHO configuration. The AS layer stops performing RRM and cell search when in a coverage gap. If a handover timer (e.g., timer T304) does not expire, the UE 208 performs HO execution to next available satellite once coverage resumes.

In some implementations, the UE 208 is configured to apply an AS centric solution when the UE 208 is in an inactive state and encounters a coverage gap due to discontinuous satellite coverage. In these implementations, the UE 208 is configured to maintain the eDRX configuration for the inactive state. That is, the UE 208 can operate with an inactive eDRX configuration during the coverage gaps.

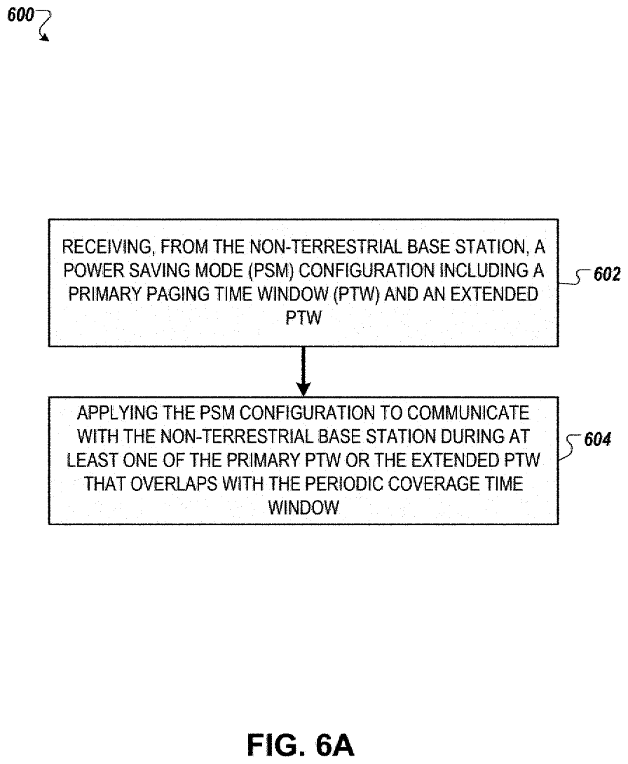

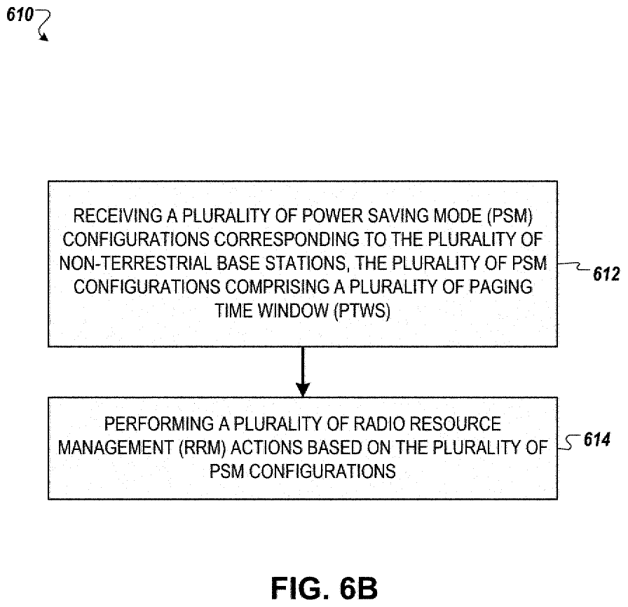

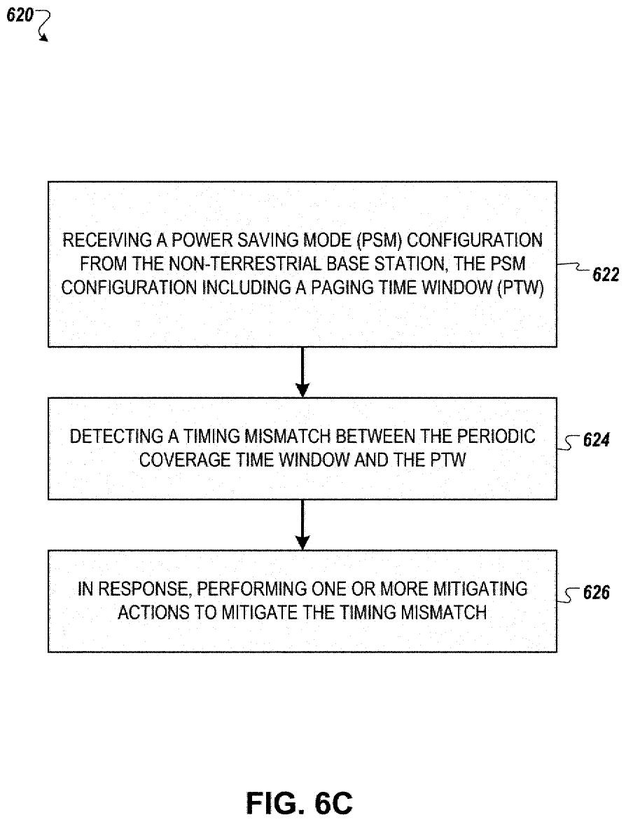

FIG. 6A illustrates a flowchart of an example method 600, according to some implementations. For clarity of presentation, the description that follows generally describes method 600 in the context of the other figures in this description. For example, method 600 can be performed by UE 208 of FIG. 2A. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

The method 600 can be performed by a UE that is periodically served by a non-terrestrial base station that provides network coverage to the UE during a periodic coverage time window.

At step 602, the method 600 involves receiving, from the non-terrestrial base station, a power saving mode (PSM) configuration including a primary paging time window (PTW) and an extended PTW.

At step 604, the method 600 involves applying the PSM configuration to communicate with the non-terrestrial base station during at least one of the primary PTW or the extended PTW that overlaps with the periodic coverage time window.

In some implementations, the extended PTW includes a preceding window that precedes the PTW and a succeeding window that succeeds the PTW.

In some implementations, the preceding window starts at a first predetermined time before the PTW, and where the succeeding window ends at a second predetermined time after the PTW.

In some implementations, applying the PSM configuration to communicate with the non-terrestrial base station during at least one of the primary PTW or the extended PTW involves: starting the preceding window at the first predetermined time; and sending the succeeding window at the second predetermined time.

In some implementations, the first predetermined time and the second predetermined time are received from the non-terrestrial base station or derived by the UE.

In some implementations, the first predetermined time and the second predetermined time are based on a number of passes that the non-terrestrial base station has made in a coverage area of the UE.

In some implementations, the method 600 further involves performing, during the primary PTW, a radio resource management (RRM) action according to a first frequency.

In some implementations, the method 600 further involves performing, during the extended PTW, the RRM action according to a second frequency, where the second frequency is an integer multiple of the first frequency.

In some implementations, the method 600 further involves determining not to communicate with the non-terrestrial base station outside of the PTW or the extended PTW.

In some implementations, the method 600 further involves prior to receiving the PSM configuration, sending assisted information to the non-terrestrial base station.

In some implementations, the assisted information includes an update request sent in a non-access stratum (NAS) message.

In some implementations, the update request includes at least one of a UE location or a UE movement status.

In some implementations, the update request includes a report prediction error indicating statistics related to the timing mismatch.

In some implementations, the assisted information is sent via communications for Self-Organizing Networks (SON).

In some implementations, the method 600 further involves detecting a mismatch between the periodic coverage time window and the primary PTW, where the assisted information is sent to the non-terrestrial base station in response to detecting the mismatch.

FIG. 6B illustrates a flowchart of an example method 610, according to some implementations. For clarity of presentation, the description that follows generally describes method 610 in the context of the other figures in this description. For example, method 610 can be performed by UE 208 of FIG. 2A. It will be understood that method 610 can be performed, for example, by any suitable system, environment, software, hardware, or a combination of systems, environments, software, and hardware, as appropriate. In some implementations, various steps of method 610 can be run in parallel, in combination, in loops, or in any order.

The method 610 can be performed by a UE that is periodically served by a plurality of non-terrestrial base stations that provide network coverage to the UE during respective periodic coverage time windows.

At step 612, the method 610 involves receiving a plurality of power saving mode (PSM) configurations corresponding to the plurality of non-terrestrial base stations, the plurality of PSM configurations including a plurality of paging time window (PTWs).

At step 614, the method 610 involves performing a plurality of radio resource management (RRM) actions based on the plurality of PSM configurations.

In some implementations, performing the plurality of RRM actions involves performing a portion of the plurality of RRM actions outside of the plurality of PTWs, where the portion of RRM actions is performed according to a frequency based on a number of layers and lengths of idle cycles of the plurality of PSM configurations.

FIG. 6C illustrates a flowchart of an example method 620, according to some implementations. For clarity of presentation, the description that follows generally describes method 620 in the context of the other figures in this description. For example, method 620 can be performed by UE 208 of FIG. 2A. It will be understood that method 620 can be performed, for example, by any suitable system, environment, software, hardware, or a combination of systems, environments, software, and hardware, as appropriate. In some implementations, various steps of method 620 can be run in parallel, in combination, in loops, or in any order.

The method 620 can be performed by a UE that is periodically served by a non-terrestrial base station that provides network coverage to the UE during a periodic coverage time window.

At step 622, the method 620 involves receiving a plurality of power saving mode (PSM) configurations corresponding to the plurality of non-terrestrial base stations, the plurality of PSM configurations including a plurality of paging time window (PTWs).

At step 624, the method 620 involves detecting a timing mismatch between the periodic coverage time window and the PTW.

At 626, the method 620 involves in response, performing one or more mitigating actions to mitigate the timing mismatch.

In some implementations, detecting the timing mismatch involves determining that the timing mismatch between the periodic coverage time window and the PTW is greater than a predetermined threshold.

In some implementations, performing the one or more mitigating actions to mitigate the timing mismatch involves: determining a time adjustment value; and extending the PTW by at least one of: (i) changing a start time of the PTW to a revised start time by subtracting the time adjustment value from an original start time, or (ii) changing an end time of the PTW to a revised end time by adding the time adjustment value to an original end time.

In some implementations, the method 620 further involves determining not to perform radio resource management (RRM) actions before the revised start time or after the revised end time.

In some implementations, the time adjustment value is based on a number of passes that the non-terrestrial base station has made in a coverage area of the UE.

In some implementations, the time adjustment value is received from the non-terrestrial base station or derived by the UE.

In some implementations, performing the one or more RRM actions to mitigate the mismatch involves skipping the one or more RRM actions in the PTW.

In some implementations, performing one or more mitigating actions to mitigate the timing mismatch involves sending assisted information to the non-terrestrial base station.

In some implementations, the assisted information includes an update request sent in a non-access stratum (NAS) message.

In some implementations, the update request includes at least one of a UE location or a UE movement status.

In some implementations, the update request requests an updated PSM configuration, and the update request includes an offset value indicative of the timing mismatch.

In some implementations, the update request includes a report prediction error indicating statistics related to the timing mismatch.

In some implementations, the assisted information is sent via communications for Self-Organizing Networks (SON).

In some implementations, the timing mismatch is a first timing mismatch, and the method 620 further involves receiving an updated PSM configuration including an updated PTW, where a second timing mismatch between the periodic coverage time window and the updated PTW is less than the first timing mismatch.

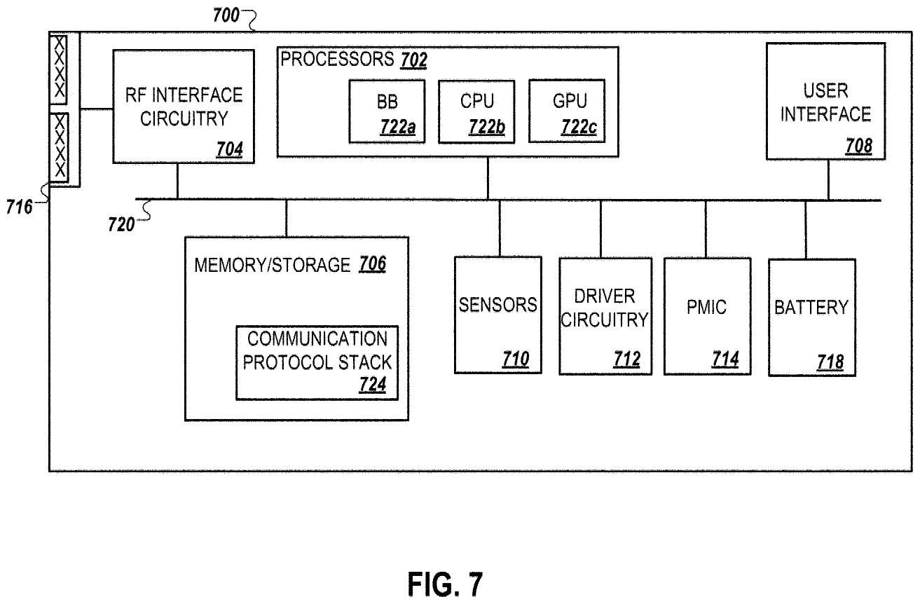

FIG. 7 illustrates a UE 700, according to some implementations. The UE 700 may be similar to and substantially interchangeable with UE 208 of FIG. 2A.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the processors 702 are configured to receive a power saving mode (PSM) configuration from the non-terrestrial base station, the PSM configuration including a paging time window (PTW) and a frequency of one or more radio resource management (RRM) actions to be performed by the UE during the PTW. The processors 702 are also configured to detect a timing mismatch between the periodic coverage time window and the PTW.

In some implementations, the processors 702 are configured to receive a plurality of power saving mode (PSM) configurations corresponding to the plurality of non-terrestrial base stations, the plurality of PSM configurations including a plurality of paging time window (PTWs). The processors 702 are also configured to perform a plurality of radio resource management (RRM) actions based on the plurality of PSM configurations.

In some implementations, the processors 702 are configured to process a power saving mode (PSM) configuration, received from a non-terrestrial base station, where the PSM configuration includes a primary paging time window (PTW) and an extended PTW. The processors 702 are also configured to apply the PSM configuration to communicate with the non-terrestrial base station during at least one of the primary PTW or the extended PTW that overlaps with the periodic coverage time window.

In some implementations, the UE 700 is periodically served by a plurality of non-terrestrial base stations that provide network coverage to the UE during respective periodic coverage time windows. In some implementations, the processors 702 are configured to process a plurality of power saving mode (PSM) configurations corresponding to the plurality of non-terrestrial base stations, where the plurality of PSM configurations including a plurality of paging time window (PTWs). The processors 702 are also configured to perform a plurality of radio resource management (RRM) actions based on the plurality of PSM configurations.

In some implementations, the UE 700 is periodically served by a non-terrestrial base station that provides network coverage to the UE during a periodic coverage time window. In some implementations, the processors 702 are configured to process a plurality of power saving mode (PSM) configurations corresponding to the plurality of non-terrestrial base stations, the plurality of PSM configurations including a plurality of paging time window (PTWs). In some implementations, the processors 702 are configured to detect a timing mismatch between the periodic coverage time window and the PTW. In some implementations, the processors 702 are configured to, perform, in response to the detection, one or more mitigating actions to mitigate the timing mismatch.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include one or more antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

FIG. 8 illustrates an access node 800 (e.g., a base station or gNB), according to some implementations. The access node 800 may be similar to and substantially interchangeable with satellite 202. The access node 800 may include processors 802, RF interface circuitry 804, core network (CN) interface circuitry 806, memory/storage circuitry 808, and one or more antenna(s) 810.

The components of the access node 800 may be coupled with various other components over one or more interconnects 812. The processors 802, RF interface circuitry 804, memory/storage circuitry 808 (including communication protocol stack 814), antenna 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

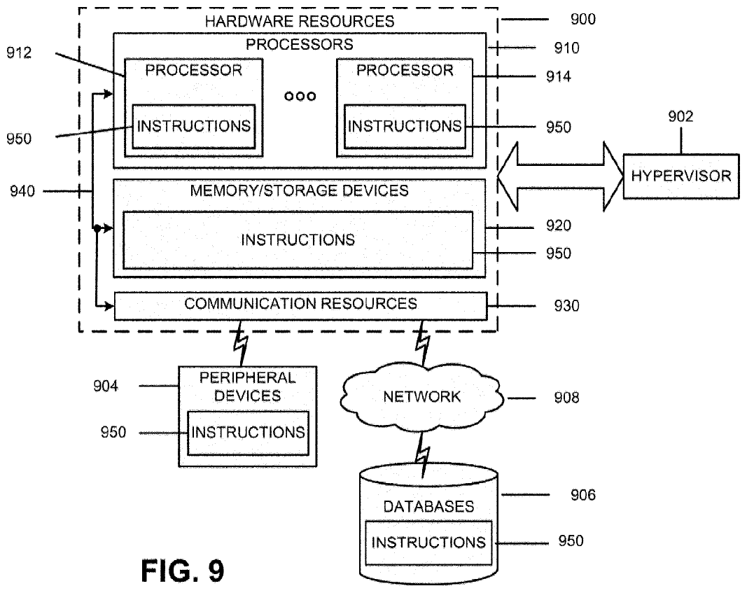

FIG. 9 is a block diagram of an example computing device 900, according to some implementations. For example, the computing device 900 can be an AMF or an MME of a core network. Specifically, FIG. 9 shows a diagrammatic representation of hardware resources including one or more processors (or processor cores) 910, one or more memory/storage devices 920, and one or more communication resources 930, each of which may be communicatively coupled via a bus 940. For embodiments where node virtualization (e.g., NFV) is utilized, a hypervisor 902 may be executed to provide an execution environment for one or more network slices/sub-slices to utilize the hardware resources.

The processors 910 may include, for example, a processor 912 and a processor 914. The processor(s) 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface components or other suitable devices to communicate with one or more peripheral devices 904 or one or more databases 906 via a network 908. For example, the communication resources 930 may include wired communication components (e.g., for coupling via USB), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources from any combination of the peripheral devices 904 or the databases 906. Accordingly, the memory of processors 910, the memory/storage devices 920, the peripheral devices 904, and the databases 906 are examples of computer-readable and machine-readable media.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method to be performed by a user equipment (UE) that is periodically served by a non-terrestrial base station that provides network coverage to the UE during a periodic coverage time window, the method comprising:
receiving, from the non-terrestrial base station, a power saving mode (PSM) configuration comprising a primary paging time window (PTW) and an extended PTW; and
applying the PSM configuration to communicate with the non-terrestrial base station during at least one of the primary PTW or the extended PTW that overlaps with the periodic coverage time window.

2. The method of claim 1, wherein the extended PTW comprises a preceding window that precedes the PTW and a succeeding window that succeeds the PTW.

3. The method of claim 2, wherein the preceding window starts at a first predetermined time before the PTW, and wherein the succeeding window ends at a second predetermined time after the PTW.

4. The method of claim 3, wherein applying the PSM configuration to communicate with the non-terrestrial base station during at least one of the primary PTW or the extended PTW comprises:
starting the preceding window at the first predetermined time; and
ending the succeeding window at the second predetermined time.

5. The method of claim 3, wherein the first predetermined time and the second predetermined time are received from the non-terrestrial base station or derived by the UE.

6. The method of claim 3, wherein the first predetermined time and the second predetermined time are based on a number of passes that the non-terrestrial base station has made in a coverage area of the UE.

7. The method of claim 1, further comprising:
performing, during the primary PTW, a radio resource management (RRM) action according to a first frequency.

8. The method of claim 7, further comprising:
performing, during the extended PTW, the RRM action according to a second frequency, wherein the second frequency is an integer multiple of the first frequency.

9. The method of claim 1, further comprising:
determining not to communicate with the non-terrestrial base station outside of the PTW or the extended PTW.

10. The method of claim 1, further comprising:
prior to receiving the PSM configuration, sending assisted information to the non-terrestrial base station.

11. The method of claim 10, wherein the assisted information comprises an update request sent in a non-access stratum (NAS) message.

12. The method of claim 11, wherein the update request comprises at least one of a UE location or a UE movement status.

13. The method of claim 11, wherein the update request comprises a report prediction error indicating statistics related to the timing mismatch.

14. The method of claim 10, wherein the assisted information is sent via communications for Self-Organizing Networks (SON).

15. The method of claim 10, the method further comprising:
detecting a mismatch between the periodic coverage time window and the primary PTW, wherein the assisted information is sent to the non-terrestrial base station in response to detecting the mismatch.

16.-27. (canceled)

28. A method to be performed by a user equipment (UE) that is periodically served by a non-terrestrial base station that provides network coverage to the UE, the method comprising:
determining, while being in a radio resource control (RRC) connected state and based on a discontinuous coverage of the non-terrestrial base station, that the UE is out of the network coverage;
responsively releasing a radio resource control (RRC) connection.

29. The method of claim 28, wherein determining that the UE is out of the network coverage comprises:
detecting a coverage gap associated with the network coverage;
in response to detecting the coverage gap, detecting the discontinuous coverage of the non-terrestrial base station.

30. The method of claim 28, wherein responsively releasing the RRC connection comprises:
transitioning from the RRC connected state to an RRC idle state.

31. The method of claim 28, wherein responsively releasing the RRC connection comprises:
informing, by an access stratum layer of the UE, to a non-access stratum layer of the UE of a reason for being out of the network coverage, the reason indicating the discontinuous coverage.

32. The method of claim 28, further comprising:
determining that the network coverage resumes; and
establishing a subsequent RRC connection with a next available non-terrestrial base station.
